(19) United States
(12) Patent Application Publication
(10) Pub. No.: US 2015/0261392 A1
(43) Pub. Date: Sep. 17, 2015

(54) ADAPTIVE INTERFACE PROVIDING APPARATUS AND METHOD

(71) Applicant: Joon SON, Seoul (KR)

(72) Inventor: Joon SON, Seoul (KR)

(21) Appl. No.: 14/295,385

(22) Filed: Jun. 4, 2014

(30) Foreign Application Priority Data
Mar. 12, 2014 (KR) 10-2014-0029083

(51) Int. Cl. G06F 3/0482; G06F 3/0488; G06F 3/0484

(52) U.S. Cl. CPC G06F 3/0482; G06F 3/0484; G06F 3/04886

(57) ABSTRACT

An interface providing method includes setting information of screen configuration involving at least one or more elements to be executed in a terminal. The method further includes providing an operation interface on a screen of the terminal by executing the elements involved in the information of screen configuration.

### CROSS-REFERENCE TO RELATED APPLICATION AND CLAIM OF PRIORITY

This application claims the benefit of Korean Patent Application No. 10-2014-0029083, filed on Mar. 12, 2014, at the Korean Intellectual Property Office, disclosures of which are incorporated herein in their entirety by reference.

### BACKGROUND

1. Field of the Invention

The present invention relates to an interface providing apparatus and method capable of providing interfaces suitable for users, depending on time, place and circumstances.

2. Description of the Related Art

Recently, as various applications are being developed and the capacity of storage media is increasing, users may be able to install various applications in their terminals, such as computers, PDAs, mobile phones, and tablet PCs.

Also, users may use different applications depending on time, place or circumstances, or may execute data stored in a storage medium. In this case, users may have trouble finding and executing their desired applications or data one by one.

### SUMMARY

In view of the above, one or more embodiments of the present invention provide an interface providing apparatus and method that are capable of providing an operation interface of a terminal adapted for time, place or environments by using the interface menu including multiple elements.

Further, one or more embodiments of the present invention provide an interface providing apparatus and method that are capable of executing various elements and properly placing on a screen depending on available times, places and circumstances of users.

Further, one or more embodiments of the present invention provide an interface providing apparatus and method that are capable to execute or shutdown at one time elements which are used frequently.

In accordance with an aspect of the present invention, provided is an interface providing method including: setting information of screen configuration involving at least one or more elements to be executed in a terminal; and providing an operation interface on a screen of the terminal by executing the elements involved in the information of screen configuration.

In the method, the setting information of screen configuration includes: requesting for selection at least one or more elements to be executed in the terminal; when any of the elements is selected in response to the request, requesting for setting a size or a location of the selected element to be disposed on the screen; and setting the information of screen configuration based on the response to the request for setting, and the selected element.

The interface providing method further includes: requesting for setting an initiating time of operation of the information of screen configuration to be executed, wherein when a time in the terminal reaches the initiating time of operation to be executed, said providing an operation interface includes executing the elements involved in the information of screen configuration with the set initiating time of operation, thereby providing the operation interface on the screen to the user.

In the interface providing method, each of the elements involved in the information of screen configuration has a priority set depending on the frequency of use thereof, and the providing an operation interface includes: determining the disposing location or size of the elements involved in the information of screen configuration in accordance with the priority of the elements; and executing the elements involved in the information of screen configuration based on the determined location or size, thereby providing the operation interface.

In the method, the providing an operation interface includes: displaying the elements involved in the information of screen configuration on the screen in a multi-window method or displaying windows corresponding to the elements involved in the information of screen configuration on the screen.

The interface providing method further includes providing a taskbar area on the screen, wherein said providing a taskbar area includes any one of: disposing all the elements involved in the information of screen configuration on the taskbar area, thereby providing the operation interface, or disposing some of the elements involved in the information of screen configuration on the taskbar area and disposing the remainder of the elements on a portion other than the taskbar area, thereby providing the operation interface.

The interface providing method further includes providing a taskbar area on the screen, wherein the providing a taskbar area includes: disposing the elements involved in the information of screen configuration on a portion other than the taskbar area, thereby providing the operation interface; and when another information of screen configuration is selected, disposing the elements involved in the information of screen configuration on the taskbar area and disposing the elements involved in the another information of screen configuration on the portion other than the taskbar area, thereby providing the operation interface.

The interface providing method further includes: monitoring the elements operated in the terminal; and creating an element and an initiating time of operation to be involved in the information of screen configuration based on the monitored element, wherein when the time in the terminal reaches a specific time zone, said providing an operation interface includes executing the elements involved in the information of screen configuration that reaches the specific time zone, thereby providing the operation interface.

The interface providing method further includes: selecting at least one or more elements in the terminal; creating an active folder by using the selected elements; and when the active folder is operated, executing the elements within the active folder.

In accordance with another aspect of the present invention, provided is an interface providing apparatus which includes: an interface menu creation unit configured to create an interface menu using information of screen configuration, the information of screen configuration involving one or more elements to be executed in a terminal; and an interface menu execution unit configured to execute the elements involved in the information of screen configuration to provide an operation interface on a screen of the terminal.

The interface providing apparatus further includes: a screen setting-up unit configured to request for selecting one or more elements to be executed in the terminal and to set the information of screen configuration using a size or a position of each of the selected elements to be disposed on the screen in response to the request, wherein the interface menu creation unit creates the interface menu through the use of the information of screen configuration provided from the screen setting-up unit.

The interface providing apparatus further includes: an information setting unit configured to set an initiating time of operation of the information of screen configuration to be executed, wherein the interface menu creation unit is configured to create the interface menu in a way of mapping the initiating time of operation to be executed and the information of screen configuration, and wherein when a time in the terminal reaches the initiating time of operation to be executed, the interface menu execution unit is configured to execute the elements involved in the information of screen configuration with the initiating time set therein, thereby providing the operation interface on the screen.

The interface providing apparatus further includes: an information setting unit configured to map a priority of frequency of use to each of the elements involved in the information of screen configuration, wherein the interface menu execution unit is configured to determine the size or location of the elements to be disposed on the screen, involved in the information of screen configuration, depending on the priority set in the respective elements and executes the elements involved in the information of screen configuration based on the determined size or location, thereby displaying them on the screen.

In the interface providing apparatus, the interface menu execution unit is configured to display the elements involved in the information of screen configuration on the screen in a multi-window method, or display windows corresponding to the elements involved in the information of screen configuration on the screen, thereby providing the operation interface.

Also, the interface menu execution unit is configured to provide a taskbar area on the screen, and wherein the interface menu execution unit is configured to dispose all the elements involved in the information of screen configuration of the interface menu on an area other than the taskbar area, thereby providing the operation interface, or the interface menu execution unit is configured to dispose some of the elements involved in the information of screen configuration on the taskbar area and dispose the remainder of the elements involved in the information of screen configuration on a portion other than the taskbar area, thereby providing the operation interface.

Also, the interface menu execution unit is configured to provide a taskbar area on the screen; dispose the elements involved in the information of screen configuration of the interface menu on a portion other than the taskbar area, thereby providing the operation interface; and when another interface menu is selected, dispose the elements involved in the information of screen configuration of the interface menu on the taskbar area and dispose the elements involved in the information of screen configuration of the another interface menu on a portion other than the taskbar area, thereby providing the operation interface.

The interface providing apparatus further includes: an active folder management unit configured to create an active folder by selecting at least one or more elements in the terminal and execute the elements within the active folder when the active folder is operated.

In the interface providing apparatus, the active folder management unit is configured to select the elements within the active folder by monitoring whether the elements are operated in the terminal.

The interface providing apparatus further includes: a training unit configured to monitor the elements operated in the terminal and create an element and an initiating time of operation to be involved in the information of screen configuration based on the monitored element, wherein the interface menu creation unit is configured to create an interface menu on a time zone basis using the information of screen configuration on a time zone basis provided from the training unit.

Also, the interface providing apparatus is implemented in a server accessible to a wired or wireless network, wherein the interface menu execution unit is configured to execute the interface menu in accordance with a request from a user's terminal via the wired or wireless network, thereby providing the operation interface to the terminal.

### BRIEF DESCRIPTION OF THE DRAWINGS

The features and advantages of the present invention will be more apparent from the following detailed description in conjunction with the accompanying drawings, in which:

FIG. 1 is an exemplary diagram illustrating an interface in accordance with an embodiment of the present invention;

FIG. 2 shows a block diagram of an interface providing apparatus in accordance with an embodiment of the present invention;

FIG. 3 is a flow chart of an operation method of an interface providing apparatus in accordance with an embodiment of the present invention;

FIG. 4 shows the steps of changing from one screen to another complying with a selection of an interface menu in the interface providing apparatus in accordance with an embodiment of the present invention;

FIGS. 5A through 5E show the steps of operations of the interface providing apparatus based on the taskbar area, in accordance with an embodiment of the present invention; and

FIGS. 6A through 6D depict exemplary screen views when the interface providing apparatus in one embodiment of the present invention is embodied for a smartphone or a tablet PC.

### DETAILED DESCRIPTION

Hereinafter, embodiments of the present invention will be described in detail with reference to the accompanying drawings. The following description is provided to aid in a comprehensive understanding of the method, apparatus and/or system disclosed herein. However, the description is exemplary in nature, and the present invention is not limited thereto.

Within the following description, well-known functions or constitutions will not be described in detail for the purposes of clarity. Further, terminology described below is defined in consideration of functions within the invention and may vary depending on a user's or operator's intention or practice. Accordingly, the definitions for the terminology may be derived on the basis of the content throughout the specification. The terms used herein are employed merely to describe specific embodiments, and are not intended to limit the present invention thereto. Representations in the singular form, unless clearly indicated otherwise, include multiple representations. In the present application, it should be understood that the terms “includes”, “comprises”, or “has”, and variants thereof, are used to specify the presence of features, figures, steps, operations, components, elements, or the combination thereof listed herein, but are not intended to exclude the possibility for the presence or supplement of one or more aspects of the features, figures, steps, operations, components, elements, or the combination thereof.

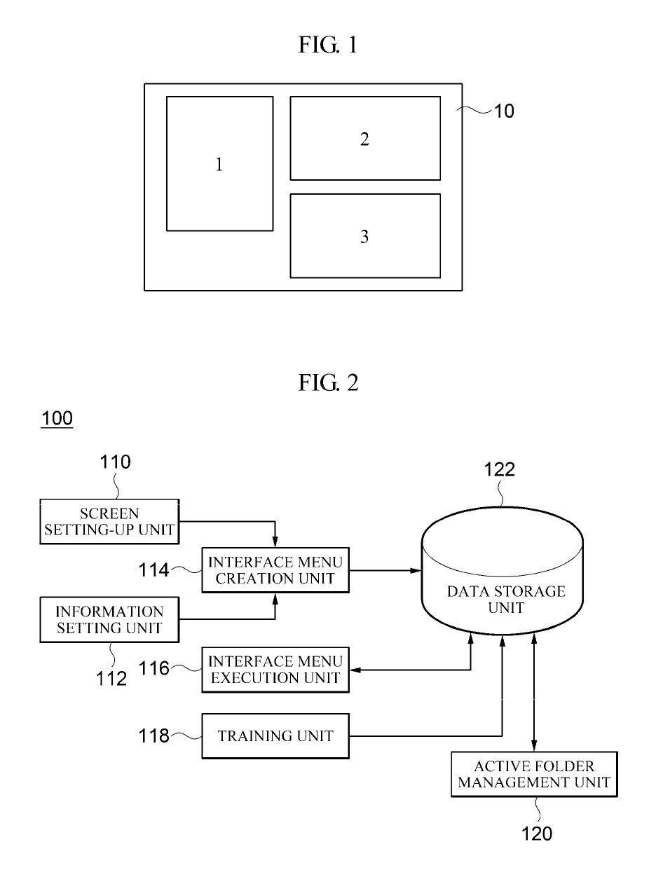

Before describing the embodiments of the present invention, the interface will be described with reference to FIG. 1.

The term “element” used herein means a function provided by an Operating System (OS) installed in a user-side terminal such as an environment setting function, software, an application, an application program, data stored in the user-side terminal, and the like. Here, the data may include Audio/Video data such as a movie and music, and the like, including documents written in Excel, Word, Hangul Word Processor (HWP), and the like.

Further, during the execution of software, applications and application programs, etc. installed in the user-side terminal, the data set by a user may be executed. For example, in the case where the element is an educational program, upon executing the element, the educational progress page set by the educational program may be displayed. Here, the educational progress page may be set by a user, or may be the page corresponding to the page when the previous educational program was finished.

In the case where the element is an Internet browser, upon executing the element, the element may access the last site visited by a user, or the site set by a user.

FIG. 1 is an exemplary diagram illustrating the interface in accordance with an embodiment of the present invention.

As shown in FIG. 1, the interface may represent the kinds of elements to be executed in the terminal and a layout of the executed elements on a screen 10 of the terminal. Specifically, the interface may represent active windows 1, 2 and 3, corresponding to multiple elements respectively, upon executing the multiple elements within the terminal, disposed on screen 10.

In one embodiment of the present invention, the terminal may include a computer, a notebook, a smartphone, a wireless communication terminal, a PDA, a tablet PC, and the like, without limitation. Specifically, the terminal may represent any of a number of devices that present dynamically or actively the execution of digital data and application programs to a user visually and that include a pointing device such as a mouse, a touch sensitive screen or other user's interactive device, or the like.

In the following embodiments of the present invention, an operation interface means that an active window with the executed element is displayed on the screen 10 of the terminal or that an element in the form of an icon is displayed on the screen 10.

Further, in the embodiments of the present invention, the operation interface may vary depending on time, place or environment. Specifically, in the embodiments of the present invention, it is possible not only to make an element to be executed differently depending on time, place or environment, but also to adjust a location and a size of the element to be disposed.

An apparatus and method for providing the aforementioned interface will be described with reference to the following drawings.

FIG. 2 is a block diagram of an interface providing apparatus 100 in accordance with an embodiment of the present invention.

The interface providing apparatus 100 of FIG. 2 may be implemented by a server accessible via a wired or wireless network or by a user-side terminal. In cases where it is implemented in the server, a user may access the server in a network-enabled space using user's own accessed terminal, for example, any computer available in a PC renting place, any terminal within a wireless network area (e.g., a smartphone, a tablet PC, a notebook, etc.) or the like, and then may use the interface service set and provided by a user from the interface providing apparatus 100.

As shown in FIG. 2, the interface providing apparatus 100 for the operation of the terminal includes a screen setting-up unit 110, an information setting unit 112, an interface menu creation unit 114, an interface menu execution unit 116, a training unit 118, an active folder management unit 120, and a data storage unit 122.

Before describing the detailed configuration of the interface providing apparatus 100, the interface providing apparatus 100 according to an embodiment may create an interface menu via a manual way, an automated way and a way via combination of manual way and automatic way, and then, using the created interface menu, may provide an operation interface suitable for a user.

The screen setting-up unit 110 in FIG. 2 provides a setting window that makes it possible to select an element to be executed in the terminal and fix a location and a size of the selected element to be disposed on the screen. Specifically, the screen setting-up unit 110 may create information of screen configuration based on data entered or operated through the setting window, i.e., information of the location and size of the element to be disposed on the screen during executing the selected element.

The information setting unit 112 may provide an input window that allows for information related to executing time, information related to executing circumstances or the like of the information of screen configuration set through the setting window to be input, and sets an initiating time of operation of the information of screen configuration based on the information entered into the input widow.

The information setting unit 112 also may provide an input window that makes it possible to set a different password for the information of screen configuration or each element involved in the information of screen configuration. The password entered into the input window may be set for the corresponding information of screen configuration or the corresponding element.

Meanwhile, the information setting unit 112 may check frequency of use of the elements in the terminal to establish a priority for each frequency of use, without providing a separate input window or setting window. The priority established as above may be provided to the interface menu creation unit 114.

The interface menu creation unit 114 may create an interface menu by mapping the information of screen configuration and the initiating time of operation set by the setting window. The created interface menu may be stored in the data storage unit 122.

Also, the interface menu creation unit 114 may automatically set the location of arrangement or the size of the element involved in the information of screen configuration based on the priority provided from the information setting unit 112, and based on the above set, may create the interface menu.

The interface menu execution unit 116 is responsible for arranging a taskbar that may be a horizontal bar located at the bottom of the screen. When a state or a time in the terminal reaches the initiating time of operation mapped in the interface menu stored in the data storage unit 122, the interface menu execution unit 116 may display the operation interface for controlling the terminal on the screen using the information of screen configuration of menus. Specifically, the interface menu execution unit 116 determines whether the initiating time of operation has been reached, based on the state or the time in the terminal. When the initiating time of operation has been reached, the operation interface corresponding to the information of screen configuration may be displayed on the screen.

For example, the interface menu execution unit 116 may provide the operation interface in a manner wherein the element involved in the information of screen configuration reached to the initiating time of operation is displayed on a taskbar area (e.g., a left area of the taskbar on the screen), or the element involved in the information of screen configuration is disposed on the screen with the previously set size and location. Here, the operation interface may mean a state that elements, for example, and/or application programs have been executed.

After any interface menu has been executed, or when another interface menu begins to be executed, the interface menu execution unit 116 may dispose the elements involved in the previous interface menu (i.e., any interface menu) on the taskbar area.

Further, in cases where there is a request for executing or selecting an element after any operation interface is provided, the interface menu execution unit 116 may provide an authentication function allowing the interface to be operated. To be more specific, upon receiving a request for executing or selecting an element, the interface menu execution unit 116 may provide an input window for a password for executing the element and carry out the authentication through the comparison between the input password and the password previously set in the element.

The interface menu execution unit 116 may provide a control window required for controlling the interface menu. The control window may provide functions such as, a selection of any one of the interface menus stored in the data storage unit 122, and movement of the menu, etc., and also may activate or inactivate the operation interface corresponding to the interface menu operated according to the operation within the control window. As used herein, the term “activate” means that the operation interface corresponding to the interface menu is displayed on the screen, whereas the term “inactivate” means that the element corresponding to the interface menu is disposed on the taskbar area.

Further, in cases where the interface menu is not selected, the interface menu execution unit 116 may provide an operation interface such that an element having a higher priority is displayed on the taskbar area.

Furthermore, in cases where the element involved in the interface menu required for execution is not set in terms of the size and the location to be disposed, the interface menu execution unit 116 may display the elements on the screen with a multi-window method.

In the embodiments of the present invention, the task bar area may be an end portion of the left, right, top, or bottom areas on the screen, without limitation. In other words, the taskbar area may be changed depending on a user's choice.

The training units 118 may monitor behaviors of a user-side terminal in real time (e.g., information of the elements that are frequently used by a user) or for a preset time and create an element and an initiating time of the operation to be involved in the information of screen configuration based on the monitored information. The created information of screen configuration and the initiating time of operation may be input into the interface menu execution unit 116 in order to be used for setting up the interface menu.

The active folder management unit 120 collects information from the elements that are frequently used by a user, through monitoring the training unit 118, and creates an active folder using the collected information from the elements. Further, the active folder management unit 120 classifies the monitored elements on a time zone basis to create the information of screen configuration on a time zone basis using the classified elements. In this regard, when a user operates an execution for the active folder, all the elements included in the active folder are executed and displayed on the screen at the same time, which may be terminated at the same time as a user operates a terminating operation. Also, the active folder management unit 120 may create an active folder using the elements selected by the screen setting-up unit 110.

The data storage unit 122 may store the interface menus created by the training unit 118, the interface menus created by the interface menu creation unit 114, and information from a plurality of elements to be managed by the active folder.

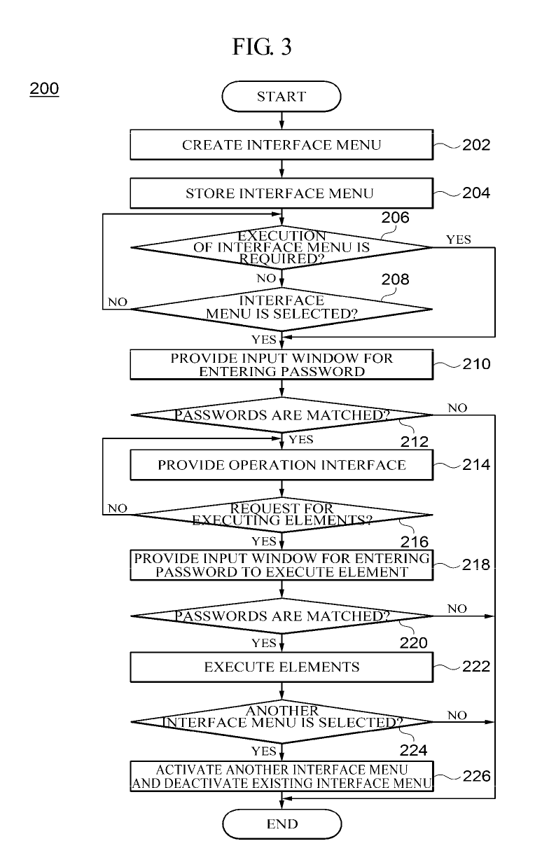

The operation method 200 of the interface providing apparatus 100 having the foregoing configuration will be described with reference to FIG. 3.

FIG. 3 is a flow chart of the operation method 200 by the interface providing apparatus 100 in accordance with an embodiment of the present invention. The method shown in FIG. 3 may be executed by, e.g., the interface providing apparatus 100. Although the method shown in the flow chart is described with a plurality of steps, at least some of the steps may be executed with changes in the sequence of steps, or may be executed together in combination with other steps, or may be omitted, or may be executed with sub-divided steps, or may be executed with the addition of one or more steps (not shown). Also, according to the embodiments, one or more steps not shown in FIG. 3 may be executed along with the method shown in FIG. 3.

As shown in FIG. 3, when selecting one or more elements be to executed by a user and inputting the settings of a location or size of the selected element to be disposed, a password required for executing the selected element or the information of screen configuration to be created and an initiating time for the operation of the information of screen configuration are carried out, the interface providing apparatus 100 may create interface menu using the input establishments and information (Block 202), and then may store them in the data storage unit 122 (Block 204). Here, the interface menu may be set up by mapping the information of screen configuration consisting of a location and a size of the selected element to be disposed, the password set for an element and an information of screen configuration, an initiating time of operation, and the like.

Next, the interface providing apparatus 100 determines whether the interface menu is necessary for executing based on the initiating time of operation (block 206). To be more specific, the interface providing apparatus 100 may determine whether the interface menu is necessary for executing, through the comparison between information of time or circumstances of the terminal and the initiating time of operation within the interface menu.

In cases where the interface menu is determined not to be necessary for executing, as a result of the determination at block 206, the interface providing apparatus 100 determines whether a user selects any one of the interface menus (Block 208).

In cases where the interface menu is selected, as a result of a determination at Block 208, the interface providing apparatus 100 provides an input window for entering a password required for executing the selected interface menu (Block 210).

Afterwards, the interface providing apparatus 100 determines whether the password entered at Block 210 and the password set in the interface menu are matched (Block 212).

When the passwords are matched, as a result of the determination at Block 212, the interface providing apparatus 100 executes the element involved in the information of screen configuration within the selected interface menu, and also disposes the element executed based on the size and location within the information of screen configuration on the screen in order to provide the operation interface (Block 214).

In cases where the interface menu is determined to be necessary for executing, as a result of the determination at Block 206, the interface providing apparatus 100 is processed to Block 210 in order to carry out the aforementioned operations.

After providing the operation interface, the interface providing apparatus 100 determines whether there is a request for operating any one of the elements displayed on the screen by a user (Block 216).

In cases where there is a request of operation, as a result of the determination at Block 216, the interface providing apparatus 100 provides an input window for entering a password required for executing the element (Block 218).

Thereafter, the interface providing apparatus 100 determines whether the password input at Block 218 and the password set in the element are matched (Block 220).

When the passwords are matched, as a result of the determination at block 220, the interface providing apparatus 100 allows the element to be operated (Block 222).

During these steps, the interface providing apparatus 100 determines whether there is a selection for another interface menu by a user (Block 224).

In cases where another interface menu is selected, as a result of the determination at Block 224, the interface providing apparatus 100 deactivates the elements involved in the previously selected interface menu, and activates the elements involved in the other selected interface menu (Block 226). Specifically, the interface providing apparatus 100 may display the elements involved in the previously selected interface menu on the taskbar area, and may display the other selected interface menu on an area other than the taskbar area (e.g., a right area of the taskbar on the screen).

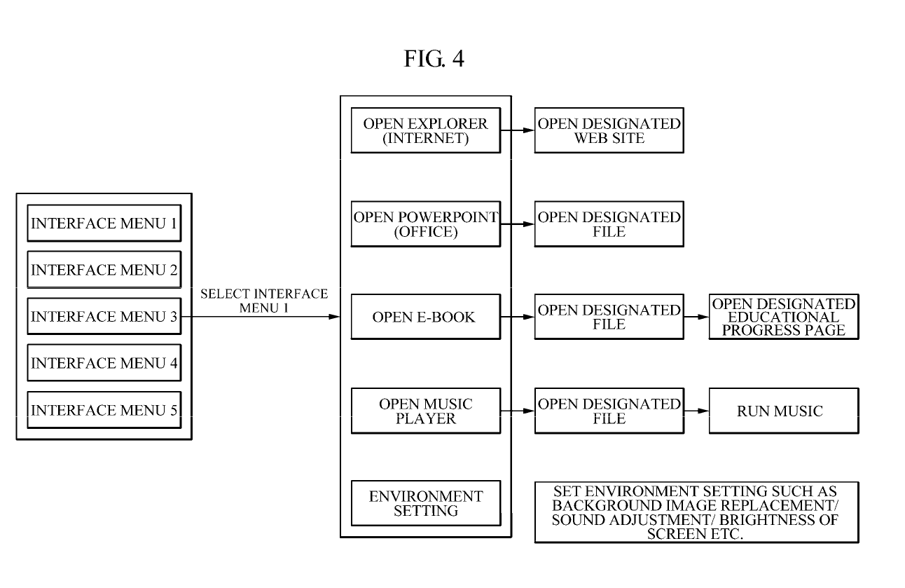

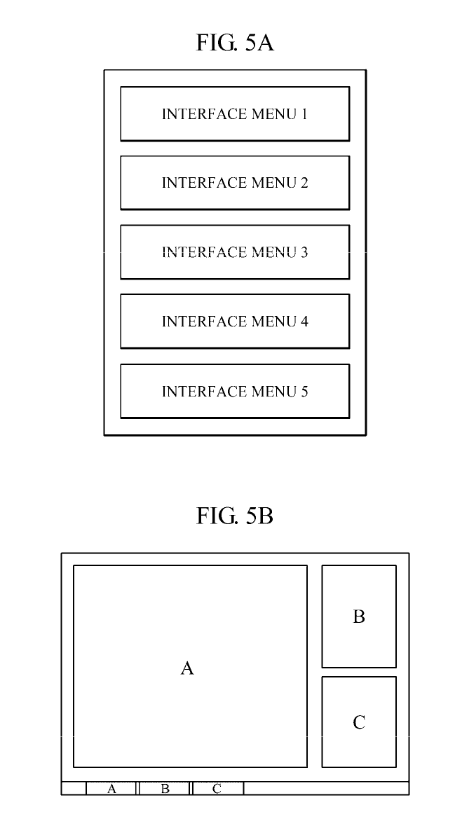

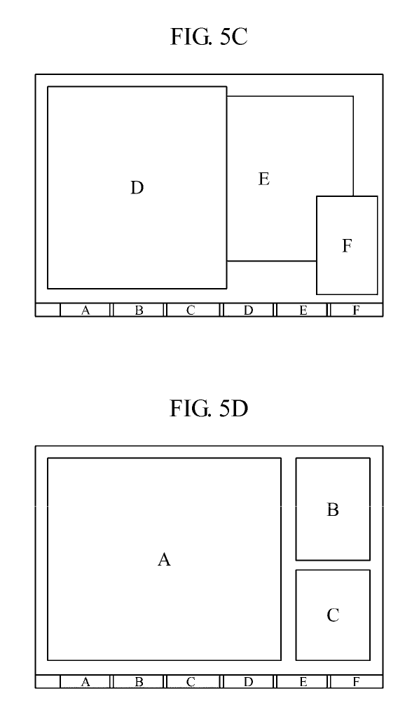

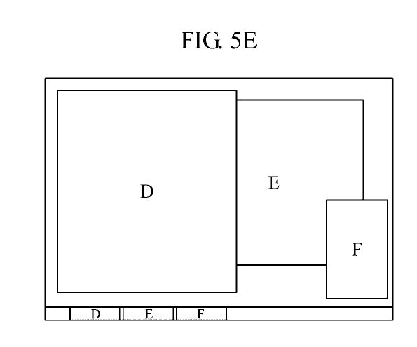

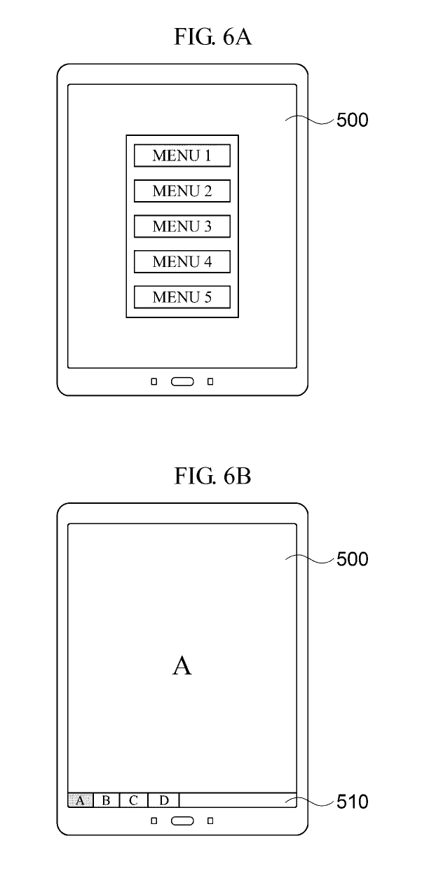

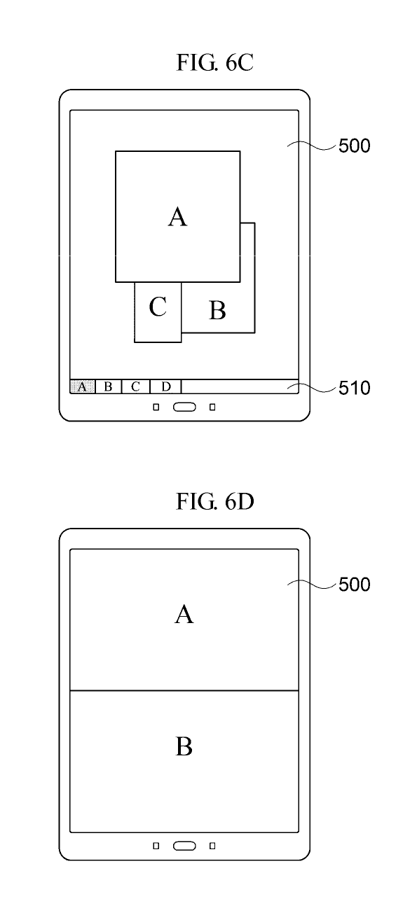

The following is a description for the execution and control of the interface menu created by the interface providing apparatus 100 having the aforementioned configuration with reference to FIG. 4, FIGS. 5A through 5E and FIG. 6.

FIG. 4 depicts the steps of changing from one screen to another complying with a selection of an interface menu in the interface providing apparatus in accordance with an embodiment of the present invention.

For ease of explanation, the following description will be made via an example wherein five interface menus are created by the interface providing apparatus 100.

First of all, when any one of the five interface menus is selected, in other words, when as shown in FIG. 4, a first interface menu which is set up with elements (e.g., “open Internet Exlporer”, “open PowerPoint”, “open e-book”, “open Music Player”, and “Environment Setting”), elements of “Inter Browser”, “PowerPoint”, “e-book”, “Music Player”, and “Environment Setting” are disposed on the screen of the terminal. In this regard, any web site set by a user may be opened on “Internet Browser”; a file set by a user may be opened on “PowerPoint”; English teaching materials set by a user may be opened on “e-book”; and a music file set by a user may be reproduced on “Music Player”.

Although this embodiment has been described by an example wherein the element opens the file (i.e., information) set by a user, the element may open a recently used file.

Next, steps for changing of the screen according to the movement between interface menus will be described with reference to FIGS. 5A through 5E.

FIGS. 5A through 5E are views illustrating the steps for the operations of the interface providing apparatus based on the taskbar area, in accordance with one embodiment of the present invention.

When a first interface menu from the five interface menus is selected, as shown in FIG. 5A, the elements A, B and C under the activated state involved in the information of screen configuration of the first interface menu are displayed on the taskbar area, and also the elements A, B and C with predetermined sizes are displayed on the remaining area of the taskbar area. Subsequently, when a second interface menu is selected, as shown in FIG. 5C, as the elements A, B and C on the taskbar area are changed from the activated state to the inactivated state, the elements D, E, and F involved in the information of screen configuration of the second interface menu are displayed on the taskbar area under the activated state, and also the elements D, E and F with predetermined sizes are displayed on the remaining area of the taskbar area.

Also, when the first interface menu is selected again, as shown in FIG. 5D, the elements A, B and C on the taskbar area are changed from the inactivated state to the activated state, and the elements D, E and F involved in the information of screen configuration of the second interface menu are changed from the activated state to the inactivated state, and the elements A, B and C, with predetermined sizes, are displayed on the remaining area except for the taskbar area.

When the second interface menu is selected, the screen of the terminal may be changed from FIG. 5D to FIG. 5C.

When the first interface menu is terminated, as shown in FIG. 5E, the elements in the information of screen configuration of the first interface menu are removed from view in the taskbar area.

Hereinafter, an example wherein the interface providing apparatus 100, related to one embodiment of the present invention, is embodied in a smartphone or a tablet PC will be described with reference to FIGS. 6A through 6D.

FIGS. 6A through 6D show exemplary screen views for the interface providing apparatus wherein one embodiment is embodied for use in a smartphone or a tablet PC.

As shown in FIG. 6A, the interface providing apparatus 100 may request a selection of the previously stored interface menus on a screen 500 of a smartphone or a tablet PC depending on an initiating time of operation or circumstances. In this regard, when a user selects any one of the interface menus, as shown in FIG. 6B, the interface providing apparatus 100 may dispose the elements, e.g., applications included in the selected interface menu on the taskbar area 510, at the bottom of the screen 500.

As shown in FIG. 6B, when any one of the elements disposed on the taskbar area 510, e.g., an element A, is selected, the interface providing apparatus 100 may display the element A on entire area of the screen 500 or on a portion of the screen 500.

Also, in cases where a user selects any one of the interface menus displayed on the screen 500, as shown in FIG. 6C, the interface providing apparatus 100 may display windows corresponding to each of the elements included in the selected interface menu on the screen 500.

When the elements are displayed by such a window-based method, the interface providing apparatus 100 may display any one of the elements, e.g., the element A with the activated state.

Also, when the elements are displayed by the above window-based method, the icons for the elements displayed on the screen 500 may be displayed on the taskbar area 510.

When a user selects any one of the interface menus displayed on the screen 500, as shown in FIG. 6D, the interface providing apparatus 100 may display the elements on the screen 500 via a multi-window method.

Although not shown in FIGS. 6C and 6D, the interface providing apparatus 100 may use a window-based method or a multi-window method, and also, similarly as in FIG. 6A, may display the elements within the selected interface menu on the taskbar area.

While the aforementioned embodiments have been shown and described by an example wherein all elements are displayed on the screen 500 via the window-based method or multi-window method, a portion of the elements may be displayed on the taskbar area 510, depending on a priority or a setting method set by a user, and the other portion of the elements may be displayed on an area except for the taskbar area 510 by the multi-window method or window-based method.

According to the aforementioned embodiments, the operation interface of the terminal is provided using an interface menu set up depending on a time, place and environment, thereby resulting in improving a user's convenience, and various elements are disposed on the screen of the terminal through the running of the elements adapted for a time, place and environment.

Further, according to the aforementioned embodiments, an active folder is provided to enable the run or finish of frequently used elements, thereby improving efficiency and convenience of users in managing the elements.

While the present invention has been described and shown in detail through embodiments, it is to be understood by those skilled in the art that the embodiments may be modified without departing from the scope of the present invention. Therefore, the scope of the present invention is not limited to the described embodiments and may be defined by the following claims and their equivalents.

What is claimed is:

1. An interface providing method, comprising:
setting information of screen configuration involving at least one or more elements to be executed in a terminal; and
providing an operation interface on a screen of the terminal by executing the elements involved in the information of screen configuration.

2. The interface providing method of claim 1, wherein said setting information of screen configuration comprises:
requesting selection of at least one or more elements to be executed in the terminal;
when any of the elements is selected in response to the request, requesting a setting of a size or a location of the selected element to be disposed on the screen; and
setting the information of screen configuration based on the response to the request for setting and the selected element.

3. The interface providing method of claim 1, further comprising:
requesting a setting of an initiating time of operation of the information of screen configuration to be executed,
wherein, when a time in the terminal reaches the initiating time of operation to be executed, said providing an operation interface comprises executing the elements involved in the information of screen configuration with the set initiating time of operation, thereby providing the operation interface on the screen to the user.

4. The interface providing method of claim 1, wherein each of the elements involved in the information of screen configuration has a priority set depending on the frequency of use thereof, and
said providing an operation interface comprises:
determining the disposing location or size of the elements involved in the information of screen configuration in accordance with the priority of the elements; and
executing the elements involved in the information of screen configuration based on the determined location or size, thereby providing the operation interface.

5. The interface providing method of claim 1, wherein the providing an operation interface comprises:
displaying the elements involved in the information of screen configuration on the screen in a multi-window method or displaying windows corresponding to the elements involved in the information of screen configuration on the screen.

6. The interface providing method of claim 1, further comprising providing a taskbar area on the screen, wherein said providing a taskbar area comprises any one of:
disposing all the elements involved in the information of screen configuration on the taskbar area, thereby providing the operation interface, or
disposing some of the elements involved in the information of screen configuration on the taskbar area and disposing the remainder of the elements on a portion other than the taskbar area, thereby providing the operation interface.

7. The interface providing method of claim 1, further comprising providing a taskbar area on the screen, wherein said providing a taskbar area comprises:
disposing the elements involved in the information of screen configuration on a portion other than the taskbar area, thereby providing the operation interface; and
when another information of screen configuration is selected, disposing the elements involved in the information of screen configuration on the taskbar area and disposing the elements involved in the another information of screen configuration on the portion other than the taskbar area, thereby providing the operation interface.

8. The interface providing method of claim 1, further comprising:
monitoring the elements operated in the terminal; and
creating an element and an initiating time of operation to be involved in the information of screen configuration based on the monitored element,
wherein when the time in the terminal reaches a specific time zone, said providing an operation interface comprises executing the elements involved in the information of screen configuration that reaches the specific time zone, thereby providing the operation interface.

9. The interface providing method of claim 1, further comprising:
selecting at least one or more elements in the terminal;
creating an active folder by using the selected elements; and
when the active folder is operated, executing the elements within the active folder.

10. An interface providing apparatus comprising:
an interface menu creation unit configured to create an interface menu using information of screen configuration, the information of screen configuration involving one or more elements to be executed in a terminal; and
an interface menu execution unit configured to execute the elements involved in the information of screen configuration to provide an operation interface on a screen of the terminal.

11. The interface providing apparatus of claim 10, further comprising:
a screen setting-up unit configured to request for selecting one or more elements to be executed in the terminal and to set the information of screen configuration using a size or a position of each of the selected elements to be disposed on the screen in response to the request,
wherein the interface menu creation unit creates the interface menu through the use of the information of screen configuration provided from the screen setting-up unit.

12. The interface providing apparatus of claim 10, further comprising:
an information setting unit configured to set an initiating time of operation of the information of screen configuration to be executed,
wherein the interface menu creation unit is configured to create the interface menu in a way of mapping the initiating time of operation to be executed and the information of screen configuration, and
wherein when a time in the terminal reaches the initiating time of operation to be executed, the interface menu execution unit is configured to execute the elements involved in the information of screen configuration with the initiating time set therein, thereby providing the operation interface on the screen.

13. The interface providing apparatus of claim 10, further comprising:
an information setting unit configured to map a priority of frequency of use to each of the elements involved in the information of screen configuration,
wherein the interface menu execution unit is configured to determine the size or location of the elements to be disposed on the screen, involved in the information of screen configuration, depending on the priority set in the respective elements and executes the elements involved in the information of screen configuration based on the determined size or location, thereby displaying them on the screen.

14. The interface providing apparatus of claim 10, wherein the interface menu execution unit is configured to display the elements involved in the information of screen configuration on the screen in a multi-window method, or display windows corresponding to the elements involved in the information of screen configuration on the screen, thereby providing the operation interface.

15. The interface providing apparatus of claim 10, wherein the interface menu execution unit is configured to provide a taskbar area on the screen, and
wherein the interface menu execution unit is configured to dispose all the elements involved in the information of screen configuration of the interface menu on an area other than the taskbar area, thereby providing the operation interface, or the interface menu execution unit is configured to dispose some of the elements involved in the information of screen configuration on the taskbar area and dispose the remainder of the elements involved in the information of screen configuration on a portion other than the taskbar area, thereby providing the operation interface.

16. The interface providing apparatus of claim 10, wherein the interface menu execution unit is configured to:
provide a taskbar area on the screen;
dispose the elements involved in the information of screen configuration of the interface menu on a portion other than the taskbar area, thereby providing the operation interface; and
when another interface menu is selected, dispose the elements involved in the information of screen configuration of the interface menu on the taskbar area and dispose the elements involved in the information of screen configuration of the another interface menu on a portion other than the taskbar area, thereby providing the operation interface.

17. The interface providing apparatus of claim 10, further comprising:
an active folder management unit configured to create an active folder by selecting at least one or more elements in the terminal and execute the elements within the active folder when the active folder is operated.

18. The interface providing apparatus of claim 17, wherein the active folder management unit is configured to select the elements within the active folder by monitoring whether the elements are operated in the terminal.

19. The interface providing apparatus of claim 10, further comprising:
a training unit configured to monitor the elements operated in the terminal and create an element and an initiating time of operation to be involved in the information of screen configuration based on the monitored element,
wherein the interface menu creation unit is configured to create an interface menu on a time zone basis using the information of screen configuration on a time zone basis provided from the training unit.

20. The interface providing apparatus of claim 10, wherein the interface providing apparatus is implemented in a server accessible to a wired or wireless network,
wherein the interface menu execution unit is configured to execute the interface menu in accordance with a request from a user's terminal that accesses via the wired or wireless network, thereby providing the operation interface to the terminal.
